(19) United States
(12) Patent Application Publication
(10) Pub. No.: US 2011/0031014 A1
(43) Pub. Date: Feb. 10, 2011

(54) Conducting wire terminal

(75) Inventor: Yung-Chou Chen, TA LI CITY (TW)

Correspondence Address: Wang Law Firm, Inc., 4989 Peachtree Parkway,, Suite 200, Norcross, GA, 30092, US

(73) Assignee: UTA AUTO INDUSTRIAL CO., LTD., TA LI CITY (TW)

(21) Appl. No.: 12/537,235

(22) Filed: Aug. 6, 2009

(51) Int. Cl. H01R 4/00

(52) U.S. Cl. 174/84 R

(57) ABSTRACT

A conducting wire terminal includes: an insulating sleeve, having two open ends, a tube body formed between the two open ends, and a first slanting guide surface formed around an internal surface of one of the open ends of the insulating sleeve and tapered towards the tube body; a copper sleeve, passed into the tube body; an internal sleeve, accommodated into another open end of the insulating sleeve; and a second slanting guide surface, formed around an internal surface of the internal sleeve and tapered towards the tube body of the insulating sleeve.

### BACKGROUND OF THE INVENTION

1. Field of the Invention

The present invention relates to a terminal, in particular to a conducting wire terminal providing an improved smooth installation of the connecting wire terminal and assuring a stable electric conduction of the connecting wire terminal after conducting wires are connected with one another.

2. Description of the Related Art

In general, two conducting wires are connected to increase the length of a conducting wire according to actual requirement of a site for the installation of the conducting wire, and a conducting wire terminal is usually provided for connecting the two conducting wires. However, a conventional manufacturing method of the conducting wire terminal as shown in FIG. 4 mainly uses a plastic injection molding machine to form a tube having two openings 61 disposed apart from each other, a body 62 disposed between the two openings 61 and having a smaller diameter than the two openings 61, and a copper sleeve 63 installed in the body 62 to form a conducting wire terminal.

However, a conventional connecting wire terminal forms a vertical stairway section 64 at an intersection of the opening 61 and an internal surface of the copper sleeve 63, and the stairway section 64 will become an obstacle during the installation of a core wire 66 of the conducting wire 65 and affect a smooth installation adversely If the conducting wire 65 is composed of a plurality of core wires 66, the external periphery of the core wire 66 may be bent easily by the stairway section 64 to affect the electric conduction power.

### SUMMARY OF THE INVENTION

It is a primary objective of the present invention to provide a conducting wire connecting wire terminal with the advantages of a low manufacturing cost, an improved smooth installation of the conducting wire terminal, an enhanced working efficiency, and a highly stable electric conduction after the conducting wire terminal is connected to the conducing wire.

To achieve the foregoing objective, the present invention provides a connecting wire terminal, comprising:

an insulating sleeve, being in a hollow tubular shape, and having two open ends, a tube body formed between the two open ends, a first slanting guide surface formed around an internal surface of one of the open ends of the insulating sleeve and tapered towards the tube body, and a stop surface formed at an intersection of the first slanting guide surface and an internal surface of the tube body;

a copper sleeve, passed into the tube body, and an end of the copper sleeve abutting against a stop surface in the tube body; and

an internal sleeve, accommodated in another open end of the insulating sleeve and an end of the internal sleeve facing the insulating sleeve tube body being abutted against another end of the copper sleeve, and having a second slanting guide surface disposed around an internal surface of the internal sleeve and tapered towards the tube body of the insulating sleeve.

### BRIEF DESCRIPTION OF THE DRAWINGS

FIG. 1 is a schematic view of a structure of the present invention;

FIG. 2 is a schematic view of an assembled structure of the present invention;

FIG. 3 is a schematic view of applying the present invention; and

FIG. 4 is a schematic view of applying a conventional connecting wire terminal.

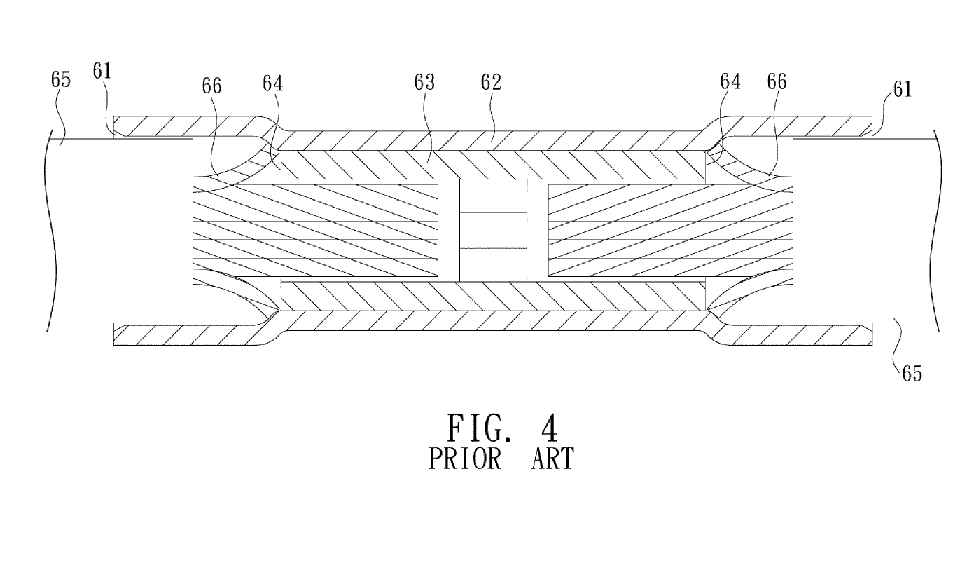

### DETAILED DESCRIPTION OF THE PREFERRED EMBODIMENTS

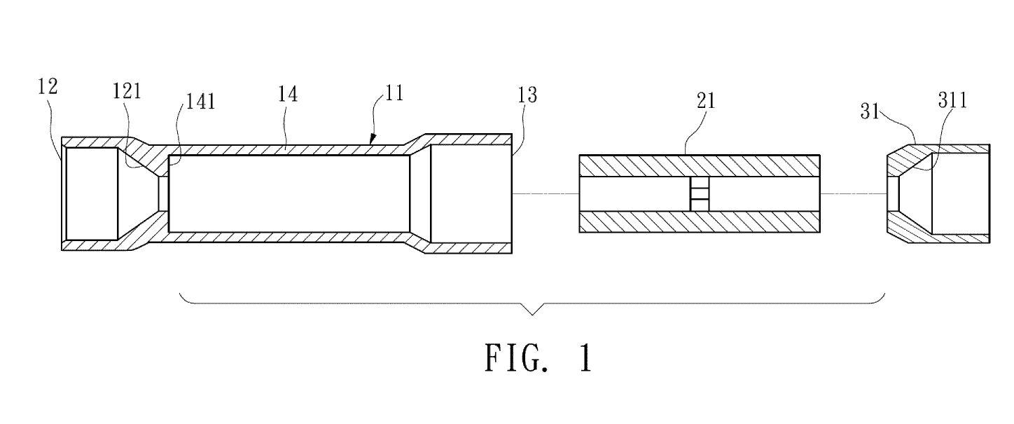

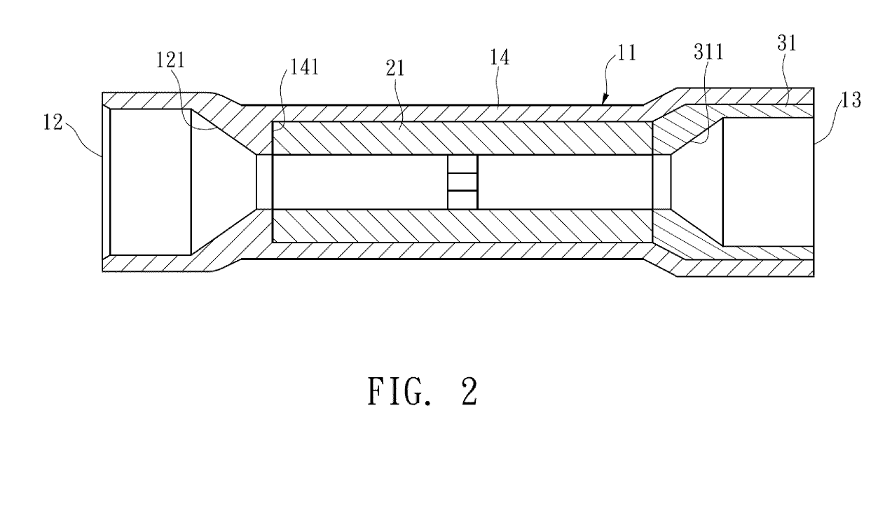

With reference to FIGS. 1 and 2 for a connecting wire terminal in accordance with the present invention, the connecting wire terminal comprises an insulating sleeve 11, a copper sleeve 21 and an internal sleeve 31.

The insulating sleeve 11 is manufactured into a hollow tubular shape by an injection molding machine, and includes two open ends 12, 13 disposed apart from one another, a tube body 14 formed between two open ends 12, 13 of the insulating sleeve 11 and interconnected with the two open ends 12, 13, a first slanting guide surface 121 disposed around an internal surface of one of the open ends 12 of the insulating sleeve 11 and tapered towards the tube body 14, and a stop surface 141 formed at an intersection of the first slanting guide surface 121 and an internal surface of the tube body 14.

The copper sleeve 21 is also in a hollow tubular shape, and passed into the tube body 14, and an external circumferential surface of the copper sleeve 21 is attached precisely with an internal surface of the tube body 14 of the insulating sleeve 11, such that when the copper sleeve 21 is accommodated in the tube body 14 of the insulating sleeve 11, an end of the copper sleeve 21 is abutted against a stop surface 141 of the tube body 14 of the insulating sleeve 11.

The internal sleeve 31 is installed into another open end 13 of the insulating sleeve 11, and an external circumferential surface of the internal sleeve 31 is attached precisely with an internal surface of another open end 13 of the insulating sleeve 11, and an end of the internal sleeve 31 facing the tube body 14 of the insulating sleeve 11 is abutted against another end of the copper sleeve 21 for fixing the copper sleeve 21 to prevent the copper sleeve 21 from falling out of the tube body, and a second slanting guide surface 311 is formed around the periphery of an internal surface of the internal sleeve 31 and tapered towards the tube body 14 of the insulating sleeve 11.

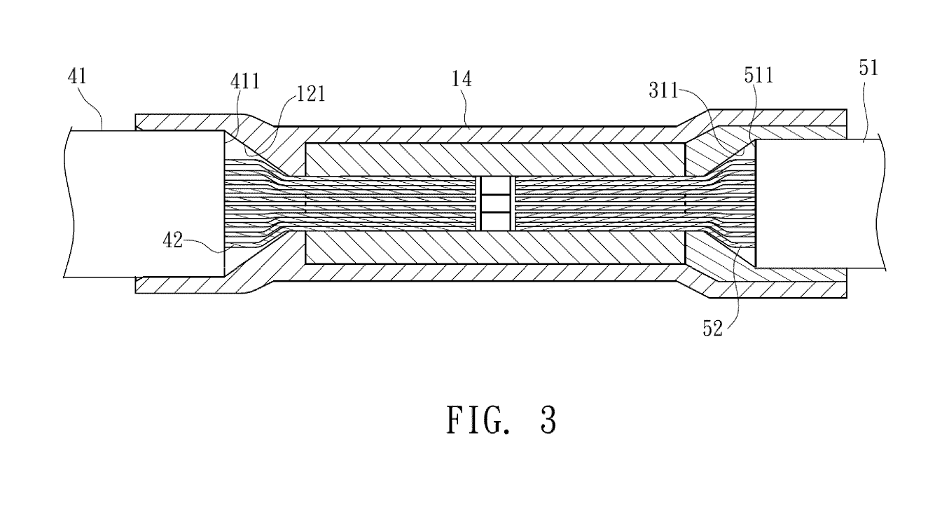

With reference to FIG. 3 for a practical application of the present invention, two opposite electric wires 41, 51 can be passed into the two open ends 12, 13 of the insulating sleeve 11 respectively, such that core wires 42, 52 of the two electric wires 41, 51 can be guided completely into the copper sleeve 21 by a first slanting guide surface 121 of the insulating sleeve 11 and a second slanting guide surface 311 of the internal sleeve 31 respectively, and the hindrance no longer exists when the two electric wires 41, 51 are connected, and the working efficiency of users is improved, and then a clamp (not shown in the figure) can be used for clamping the tube body 14 of the insulating sleeve 11, such that the two electric wires 41, 51 can be fixed because the core wires 42, 52 are clamped by the copper sleeve 21 to achieve the electric conduction effect.

Since the slanting guide surfaces 121, 311 can guide the core wires 42, 52 of the two electric wires 41, 51 completely into the copper sleeve 21, and a jacket 411, 511 of each electric wire 41, 51 is stopped by the slanting guide surfaces 121, 311 and cannot be entered into the copper sleeve 21. In other words, larger ends of the two slanting guide surfaces 121, 311 are provided for installing the electric wire jacket 411, 511, and the slanting guide surfaces 121, 311 tapered towards the internal surface of the tube body 14 can block the jacket 411, 511 of the electric wire, and just allows the core wire 42, 52 of the electric wire to pass through, so as to assure a stable electric conduction after the two electric wires 41, 51 are connected.

The connecting wire terminal of the present invention has the following advantages:

1. With the design of the first slanting guide surface of the insulating sleeve and the second slanting guide surface of the internal sleeve in accordance with the present invention, the desired connecting core wires of the electric wire are guided into the copper sleeve, such that no hindrance occurs during the process of connecting the two electric wires. Thus, the invention provides a quick and convenient installation to improve the working efficiency of users effectively.

2. With the design of the first slanting guide surface and the second slanting guide surface in accordance with the present invention, the jacket of the electric wire can be prevented from entering into the copper sleeve. Thus, the invention assures a stable electric conduction when the two electric wires are connected.

3. An end of the copper sleeve of the present invention is abutted against the stop surface at an internal surface of the tube body, and another end of the copper sleeve is pressed by the internal sleeve for positioning the internal sleeve and limiting the position of the copper sleeve to prevent the copper sleeve from falling out of the tube body.

What is claimed is:

1. A connecting wire terminal, comprising:
an insulating sleeve, being in a hollow tubular shape, and having two open ends, a tube body formed between the two open ends, a first slanting guide surface formed around an internal surface of one of the open ends of the insulating sleeve and tapered towards the tube body, and a stop surface formed at an intersection of the first slanting guide surface and an internal surface of the tube body;
a copper sleeve, passed into the tube body, and an end of the copper sleeve abutting against a stop surface in the tube body; and
an internal sleeve, accommodated in another open end of the insulating sleeve, and an end of the internal sleeve facing the insulating sleeve tube body being abutted against another end of the copper sleeve, and having a second slanting guide surface disposed around an internal surface of the internal sleeve and tapered towards the tube body of the insulating sleeve.

2. The connecting wire terminal of claim 1, wherein the copper sleeve has an external circumferential surface attached with an internal surface of the tube body of the insulating sleeve, and the internal sleeve has an external circumferential surface attached with an internal surface of another open end of the insulating sleeve.
